(19) United States
(12) Patent Application Publication
(10) Pub. No.: US 2009/0234628 A1
(43) Pub. Date: Sep. 17, 2009

(54) PREDICTION OF COMPLETE RESPONSE GIVEN TREATMENT DATA

(75) Inventors: Shipeng Yu, Exton, PA (US); Glenn Fung, Madison, WI (US); Cary Dehing-Oberije, Brunssum (NL); Lucas Carolus Gertrudis Gerardus Persoon, Berg en Terblijt (NL); Sriram Krishnan, Exton, PA (US); R. Bharat Rao, Berwyn, PA (US); Philippe Lambin, Genappe Bousval (BE); Ruud G.P.M. Van Stiphout, Eindhoven (NL); Jeroen Buijsen, Schimmert (NL); Guido Lammering, Aachen (DE); Marco Janssen, Haelen (NL); Eric Postma, Maastricht (NL); Vincenzo Valentini, Roma (IT)

Correspondence Address: SIEMENS CORPORATION;INTELLECTUAL PROPERTY DEPARTMENT, 170 WOOD AVENUE SOUTH, ISELIN, NJ, 08830, US

(73) Assignees: Siemens Medical Solutions USA, Inc., Malvern, PA (US); MAASTRO clinic, Maastricht (NL)

(21) Appl. No.: 12/400,868

(22) Filed: Mar. 10, 2009

Related U.S. Application Data
(60) Provisional application No. 61/036,512, filed on Mar. 14, 2008.
(60) Provisional application No. 61/036,514, filed on Mar. 14, 2008.

(51) Int. Cl. G06G 7/48; G06F 15/18

(52) U.S. Cl. 703/11; 706/12

(57) ABSTRACT

A system for modeling complete response prediction is provided. The system includes an input that is operable to receive treatment information representing treatment data that may be used to predict a complete response of a tumor. The complete response may include a disappearance of all or substantially all of a disease. A processor may be operable to use a model to predict complete response of the tumor as a function of the treatment data. The model represents a probability of complete response to treatment given the treatment data. A display is operable to output an image as a function of the complete response prediction.

### RELATED APPLICATIONS

The present patent document claims the benefit of the filing date under 35 U.S.C. §119(e) of Provisional U.S. Patent Application Ser. No. 61/036,512, filed Mar. 14, 2008, and of Provisional U.S. Patent Application Ser. No. 61/036,514, filed Mar. 14, 2008, which are both hereby incorporated by reference.

### BACKGROUND

The present embodiments relate to predicting complete response of a tumor to a treatment. Complete response includes a disappearance of all or substantially all of a disease.

A rectal cancer tumor is treated with chemotherapy or radiotherapy. When treatment with chemotherapy or radiotherapy is completed, an oncologist reviews the response to treatment after a regression period (residual period). The regression period allows the tumor to shrink, regress, and the dead tumor cells to be removed by the body. At the time of response assessment, which is at the end of the regression period, a patient is reviewed by clinical examination, scans, blood tests, or marker studies. Based on the findings of these tests, a medical professional describes the actual response to treatment (“treatment response”) as a complete response, partial response, stable disease, or progressive disease.

A complete response indicates that the there is no or substantially no disease remaining in the body. A partial response indicates that there is some disease remaining in the body, but that there has been a decrease in size or number of lesions (e.g., by 30% or more). Stable disease indicates that the disease has remained generally unchanged in the size and number of lesions (e.g., generally, a less than 50% decrease or a slight increase in size would be described as stable disease). Progressive disease indicates that the disease has increased in size or number.

The treatment response may be determined after the regression period. In other words, a post-treatment treatment plan for the tumor may not be determined until the end of the regression period.

### SUMMARY

The present embodiments relate to modeling complete response of a tumor to treatment. Complete response includes a disappearance of all or substantially all of a disease. After treatment, a patient may be assessed for treatment response after a period of time, which may be referred to as the regression period. The regression period allows for regression of the tumor. At the end of the regression period, if there is no or substantially no residual disease that can be identified on a clinical examination by the doctor, or on x-rays and scans, or lab tests for the disease or its markers, the treatment response is considered a complete response (or complete regression). Complete response does not imply cure. Some people with a complete response may have a tumor recurrence later. The prediction occurs before the regression period ends, allowing for further treatment planning prior to a final decision and/or test results.

In one aspect, a system for modeling complete response prediction is provided. The system includes an input, a processor, and a display. The input is operable to receive treatment information representing treatment data for treating a tumor. The processor is operable to use a model to predict an indication of a chance of a complete response of the tumor to treatment given the treatment data. The prediction is a function of the treatment data. The complete response includes a disappearance of all or substantially all of a disease. The display is operable to output an image as a function of the complete response prediction.

In a second aspect, a computer readable storage medium having stored therein data representing instructions executable by a programmed processor for predicting complete response. The computer readable storage medium comprising instructions for receiving treatment data for a disease of a tumor. The treatment data including pre-treatment data and post-treatment data. The storage medium including instructions for predicting a chance of disappearance of all or substantially all of the disease of the tumor as a function of the treatment data and instructions for determining surgical operation information as a function of the predicted chance, the surgical operation information indicating whether a surgical operation is needed to remove the disease. The storage medium including instructions for outputting an image representing the surgical operation information.

In a third aspect, a method for modeling complete response predictions is provided. The method collecting treatment data for treatment of a tumor. The treatment data includes pre-treatment data and post-treatment data. Response of a tumor is classified as a function of complete response probability given the collected treatment data. The complete response probability is machine-learned from a dataset for other patients having treatment data before and after treatment by radiation. Response information is determined as a function of the response. The response information indicates whether there will be a complete response to treatment for the patient. The response information is output.

Any one or more of the aspects described above may be used alone or in combination. These and other aspects, features and advantages will become apparent from the following detailed description of preferred embodiments, which is to be read in connection with the accompanying drawings. The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

FIG. 1 illustrates one embodiment of a system for predicting complete response;

FIG. 2 illustrates one embodiment of a time table for treating rectal cancer patients;

FIG. 3 illustrates another embodiment of a system for predicting complete response;

FIG. 4 illustrates one embodiment of a method for predicting complete response; and

FIG. 5 illustrates one embodiment of a flow chart for treating rectal cancer tumors.

### DETAILED DESCRIPTION

The present embodiments relate to modeling complete response of a tumor to treatment. Complete response includes a disappearance of all or substantially all of a disease. Complete response may include pathological complete response. As used herein, “substantially” includes enough that further treatment is not needed. The present embodiments may relate to creating a complete response model. The complete response model is applied to predict complete response given treatment data. The treatment data may be pre-treatment data, post-treatment data, or a difference between pre-treatment data and post-treatment data. Post-treatment treatment plans may be determined based on the complete response prediction. For example, instead of waiting until the end of a regression period to perform a surgical operation to remove the tumor, the tumor may be removed before the end of the regression period, or plans to remove the tumor based on the predication are made assuming the analysis confirms the prediction at the end of the regression period. The decision to surgically remove the tumor may be based on the complete response prediction. Accurate prediction is desired.

Complete response of a rectal cancer tumor may be predicted. Rectal cancer is a curable and a frequently occurring or reoccurring malignancy. The treatment of rectal cancer may include a pre-operative treatment (e.g., chemo-radiotherapy) and an operation treatment (e.g., a surgical procedure). After the pre-operative treatment, a medical professional determines whether to perform the operative treatment. Prediction of complete response aids the medical professional in making this decision. Complete response prediction may indicate the probability of complete response to the pre-operative treatment. Complete response may be predicted for other body parts and/or diseases, cancers, and tumors.

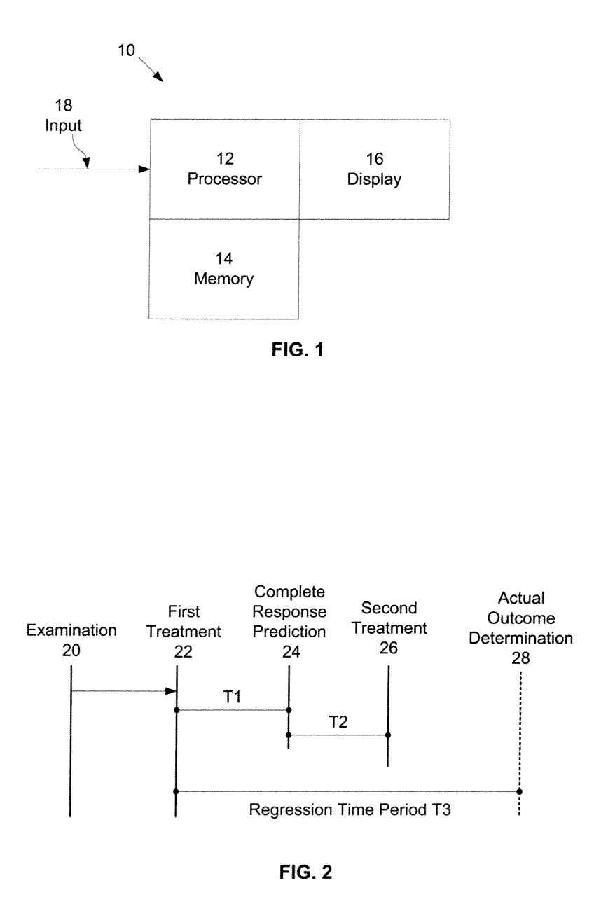

FIG. 1 shows is a block diagram of an example system 10 for modeling complete response. The system 10 is shown as a hardware device, but may be implemented in various forms of hardware, software, firmware, special purpose processors, or a combination thereof. Some embodiments are implemented in software as a program tangibly embodied on a program storage device. By implementing with a system or program, semi-automated workflows are provided to assist a user in generating a prediction of treatment outcome. Data representing a patient is transformed into an image or data indicating effectiveness of treatment.

The system 10 is a computer, personal computer, server, PACs workstation, imaging system, medical system, network processor, network, or other now know or later developed processing system. The system 10 includes at least one processor (hereinafter processor) 12, at least one memory (hereinafter memory) 14, a display 16, and at least one input (hereinafter input) 18. The processor 12 may be communicatively coupled with the memory 14, the display 16, and the input 18. “Coupled with” includes directly connected to or indirectly connected through one or more intermediary components. The one or more intermediary components may be hardware or software components. In alternative embodiments, the system 10 may include additional, different, or fewer components.

The processor 12 is implemented on a computer platform having hardware components. The computer platform also includes an operating system and microinstruction code. The various processes, methods, acts, and functions described herein may be either part of the microinstruction code or part of a program (or combination thereof) executed via the operating system.

The input 18 is a user input, network interface, external storage, or other input device for providing data to the system 10. For example, the input 18 is a mouse, keyboard, track ball, touch screen, joystick, touch pad, buttons, knobs, sliders, combinations thereof, or other now known or later developed user input device. The user input may operate as part of a user interface. For example, one or more buttons are displayed on the display 16. The user input is used to control a pointer for selection and activation of the functions associated with the buttons. Alternatively, hard coded or fixed buttons may be used. As another example, the input 18 is a hard-wired or wireless network interface. A universal asynchronous receiver/transmitter (UART), a parallel digital interface, a software interface, Ethernet, or any combination of known or later developed software and hardware interfaces may be used. The network interface may be linked to various types of networks, including a local area network (LAN), a wide area network (WAN), an intranet, a virtual private network (VPN), and the Internet.

The input 18 is an interface to receive data. Treatment data is received. Treatment data may be biological data, clinical data, image data, a combination thereof, or other data determined to be relevant to the treatment of a tumor and/or prediction of complete response. The treatment data may be pre-treatment data and/or post-treatment data. Pre-treatment data is data obtained prior to treatment of the tumor, for example, prior to a chemotherapy treatment of the tumor. Post-treatment data is data obtained during or after treatment of the tumor, for example, after a chemotherapy treatment of the tumor.

Biological data may include patient clinical characteristics, such as the patient's age, gender, weight, genetic information, family history, regime, dose, time, type, medicine, or height. Genetic information may relate to genes, such as active or passive genes. Clinical data may include treatment characteristics, such as type, strength, and length of treatment that is to be performed, and other clinical evaluations, such as performance score (WHO, Karnofsky). Image data may include characteristics obtained using imaging. Image data may include tumor characteristics, such as tumor size (e.g., gross tumor volume (GTV)), tumor location, and standard uptake value (SUV). The biological data and clinical data may be determined without imaging the tumor, and the image data may be determined with an imaging procedure, such as positron emission tomography (PET).

In one embodiment, the image data includes blood biomarkers, uptake, or other imaging or test information. Combinations of information may be received, such as both blood biomarkers and uptake information. Any combination of information may be used. Any derived quantities or raw data may be used. The image data may include functional imaging information. Functional imaging information includes an image, data to generate an image, quantities derived from a functional scan, or other data that is a function of functional imaging data. Functional imaging data represents metabolic or biochemical activity of a tumor. For example, positron emission tomography is used with fluorodeoxyglucose (FDG) for scanning a rectal cancer tumor. The FDG highlights, binds to, or is taken up by glucose, showing glucose metabolism in the PET data. “Uptake” is used to reflect binding, absorption, tagging, labeling, connecting, or other reaction of an agent to the tissue. Other now known or later developed functional imaging modes may be used. Other now known or later developed binding or contrast agents to identify function in the scan region may be used. In alternative embodiments, the imaging modality identifies tissue function based on data processing without introduction of a contrast or binding agent. Other types of tumors may be scanned.

In another embodiment, the image data includes PET-FDG data. The PET-FDG data may be acquired with a computer tomography (CT)-PET imaging system. The imaging system generates both CT and PET information. Other imaging modes, magnetic resonance imaging (MRI), or combinations of imaging modes may be used, such as MRI-PET, as image data.

Although described as different types of treatment data, the biological data, clinical data, and image data may be referred to as or include other types of data. For example, in some systems, clinical data may be referred to as biological data, or vice-versa. In other systems, image data is referred to as clinical data. Other names, references, or identifications may be used

FIG. 2 shows an exemplary time table for treating rectal cancer. In FIG. 2, the examination 20 may include a patient examination and an imagining procedure. The patient examination may include collecting and gathering patient information, for example, by weighing the patient on a scale, reading the patient's medical history, or asking the patient questions. The patient information may be biological data. The imagining procedure, for example, using a CT scan or PET device, may be performed to determine information about the tumor, such as the location of the tumor on the patient's rectum or the size of the tumor. The information about the tumor may be image data. The medical professional may then set the treatment parameters, such as the radiation dose (e.g., 25-60 Gy) to be used during the first treatment 22, based on the biological and/or image data. The treatment parameters may be clinical data. After treatment, further data is input and/or a complete response predication 24 is made by the processor 12.

The first treatment 22 may be a pre-operative treatment, such as chemotherapy treatment, radiotherapy treatment, a combination thereof (e.g., chemo-radiotherapy), or another treatment for treating tumors. The first treatment 22 may be performed, for example, to decrease the size of the tumor, prepare the tumor for the second treatment 26, or determine how the tumor reacts to the first treatment 22. The second treatment 26 may be an operation treatment, such as a surgical procedure to remove the tumor. The second treatment 26 may be performed at any time after the first treatment 22.

Chemo-radiotherapy is commonly administered to treat rectal cancer. Chemo-radiotherapy may be a combination of chemotherapy and radiotherapy. The chemotherapeutics of chem-radiotherapy, such as oral 5-FU (Capecitabine), are usually given concomitantly. As a result, the local control of the chemotherapy is improved in combination with radiotherapy. Preoperative chemo-radiotherapy may be superior to postoperative a chemo-radiotherapy, not only in terms of local control and morbidity, but it can significantly improve the likelyhood of microscopically free resection margins and sometimes even lead to pathologic complete remissions, which might potentially allow to omit surgery. In order to treat locally advanced rectal cancer, a preoperative chemo-radiotherapy treatment may be followed by a total mesorectal excision.

Referring again to FIG. 1, the processor 12 has any suitable architecture, such as a general processor, central processing unit, digital signal processor, application specific integrated circuit, field programmable gate array, digital circuit, analog circuit, combinations thereof, or any other now known or later developed device for processing data. Likewise, processing strategies may include multiprocessing, multitasking, parallel processing, and the like. A program may be uploaded to, and executed by, the processor 12. The processor 12 implements the program alone or includes multiple processors in a network or system for parallel or sequential processing.

The processor 12 creates a model, applies the model, or both creates and applies the model. The model is of a tumor's treatment response to a treatment dose. For example, the model may be of complete response to a treatment dose. Any type of treatment dose may be modeled, such as radiation, chemotherapy, laser, heat, or other now known or later developed therapies.

In one embodiment, the model is a machine-learned model. For example, a model predicting complete response is machine trained. Any machine-learning algorithm or approach to classification may be used. For example, a support vector machine (e.g., 2-norm SVM), linear regression, boosting network, linear discriminant analysis, relevance vector machine, combinations thereof, or other now known or later developed machine learning is provided. The machine learning provides a matrix or other output. The matrix is derived from analysis of a database of training data with known results, such as a database of data with binary or a larger range of possible labeled outcomes. The machine-learning algorithm determines the relationship of different inputs to the result. The learning may select only a sub-set of input features or may use all available input features. A programmer may influence or control which input features to use or other performance of the training. For example, the programmer may control the amount of variance or smoothness of a hyperplane or line in SVM training. The matrix associates input features with outcomes, providing a model for classifying. Machine training provides relationships using one or more input variables with outcome, allowing for verification or creation of interrelationships not easily performed manually.

Alternatively, manually programmed models may be used. For example, a model predicting complete response is programmed. The model may be validated using machine training.

The model represents a probability of complete response. Probability may include a mathematical probability (e.g., 0-1), non-mathematical probability (e.g., a score including a likelihood factor), chance, likelihood, or other prediction indicator. Probability is the likelihood for the disease of interest, such as rectal cancer, to have a certain outcome, such as complete response to the treatment. The likelihood is modeled from any rectal cancer patient information. Any feature may be used. Other probabilities may be used. Alternatively, the probability is based on measurements during treatment, such a reoccurrence or other treatment responses.

The probability is learned or derived from data for other patients, training data. The database of other patients includes clinical, imaging, and/or other data from before therapy and at the desired time after or during therapy. The dose applied to the tumor and/or regions of the tumor for treatment may be included. Other features may be provided, such as age, gender, WHO performance, tumor type, and tumor size. Different feature vectors may be provided for different types of tumors, different models, and/or different probabilities (e.g., complete response verses another response catagory). Pre-treatment data and post-treatment data may be used. Differences between pre-treatment data and post-treatment data may be used. For example, a difference in tumor size may be used.

The functional imaging (e.g., uptake values) or other input feature information may be normalized. For example, uptake values are normalized based on uptake for healthy tissue. The normalized uptake values provide standardized uptake values (SUV). The SUV at a given time may be an integral of the SUV for a tumor. A change in SUV is determined by a difference between the integrals of SUV. The model is trained based on the difference in SUV, but may use other SUV parameters.

The processor 12 applies the model or models. The treatment data and/or other data of relevant feature vectors is input into the model or models. The information may be input according to requirements, such as inputting values in specific units. Alternatively, raw data is input and the model includes preprocessing to derive the values used by the model.

Different inputs may be used for different models. For example, complete response may be predicted using a feature vector including tumor size, age, body mass index, and treatment dose. Missing data may be substituted with an average, median, or default value. Alternatively, missing data may be left blank where the model may still provide sufficient accuracy.

In response to the input, the model outputs a probability. The probability may be a complete response predication, such as a mathematical statistic, non-mathematical score, chance, or other likelihood of complete response. The output is a complete response prediction. For example, the likelihood of complete response is output. In another example, the likelihood of a patient needing surgical intervention is output. The processor 12 outputs the probability or probabilities for creating or using the models. The processor 12 outputs the data to the memory 14, display 16, over or to a network, to a printer, or in other media.

The processor 12 assists the medical professional to create a treatment plan, which gives the best treatment (e.g., the highest chance of tumor control at acceptable probability). For example, if complete response was not achieved with the treatment dose, then a surgical operation may be needed to remove the tumor. Referring to FIG. 2, the processor 12 may predict complete response, for example, at the complete response prediction 24. The time period T1 between the first treatment 22 and the complete response prediction 24 may be 1-2 weeks. The processor 12 may determine whether the complete response prediction is prediction positive or prediction negative.

Prediction negative indicates that there will not be complete response at the end of the regression period. As shown in FIG. 2, at the actual outcome determination 28, the treatment response is predicted to be not a complete response. Prediction negative may indicate that a surgical operation is needed or may be likely. The second treatment 26 may be scheduled and/or performed. The time period T2 between the complete response prediction 24 and the second treatment 26 may be, for example, 1-2 weeks. Accordingly, the total time (T1+T2) from the first treatment 22 to the second treatment 26 may be, for example, 2-4 weeks. More time may be required without the use of the prediction, since the surgery would not be considered and/or scheduled until after the actual outcome determination 28 at the end of the regression period T3.

Prediction positive indicates that there likely will be complete response at the end of the regression time period. As shown in FIG. 2, the treatment response is predicted to be a complete response at the actual outcome determination 28. The period from the first treatment 22 to actual outcome determination 28 may be the regression time period T3. One exemplary regression time period T3 is 6-8 weeks. Prediction positive may indicate that a surgical operation is not needed since the treatment is likely to have removed the disease.

One benefit of the complete response prediction is that surgical operations (or other additional treatments) may be performed as soon as possible. In contrast to waiting for the actual outcome determination 28 to determine whether there was complete response, medical professionals may predict whether there is going to be complete response and adjust the patient's treatment plan accordingly. The total time period (T1+T2) from the first treatment 22 to the second treatment 26 may be less than the regression time period T3. Alternatively, the second treatment 26 occurs immediately after the actual outcome determination due to the pre-scheduling. Prediction with sufficient accuracy may avoid scheduling and cancelling frequently, making the treatment process more efficient. Accordingly, treatment plans based on complete response prediction may be more efficient, effective, and safer than waiting for the actual outcome determination 28.

Another benefit of the complete response prediction is improving the accuracy of determining whether the second treatment 26 is even necessary. For example, the complete response prediction 24 may be used to determine whether the second treatment 26 is even necessary. The complete response prediction 24 may indicate complete response or high likelihood of complete response to the first treatment 22 for the rectal cancer tumor. As a result, the medical professional may cancel the second treatment 26. Accordingly, the patient is saved from undergoing a surgical operation. Alternatively, or additionally, the complete response prediction may indicate that further non-surgical treatment, for example, chemo-radiotherapy, will likely be sufficient in treating the tumor.

Referring back to FIG. 1, the processor 12 may update a database (or dataset). The database may include the training information. For example, the processor 12 may update the training information to include the actual outcome of the treatment. Updating may include substituting, adding, subtracting, amending, changing, or including the actual determination. All, some, or none of the actual outcome determination may be updated. For example, the treatment response, treatment data, or other information related to the administered treatment may be updated. One benefit of updating the database is that the next time a model is created from the database, the model may be more accurate.

The processor 12 outputs the probabilities, prediction positive image, prediction negative image, charts, values, plan, and/or other information for creating or using the models. A prediction positive image may represent a prediction positive determination. The prediction negative image may represent a prediction negative determination. For example, an image with the statement “Likelihood of complete response: X %” is output as part of an image. The image may include comparative information, such as a distribution of probabilities associated with needing and not needing surgery. The processor 12 outputs the data to the memory 14, display 16, over or to a network, to a printer, or in other media.

The output and/or inputs may be displayed to a user on the display 16. The display 16 is a CRT, LCD, plasma, projector, monitor, printer, or other output device for showing data. The display 16 is operable to display an image. The image may be of a medical image, a prediction positive image, a prediction negative image, a user interface, charts, graphs, values, or other information, such as the complication prediction, survivability prediction, or both. For example, the display 16 outputs an image generated with information output from the complete response model for the rectal cancer patient. The image shows the predicted likelihood with or without other information. The likelihood is based on data specific to or representing a given patient. More than one likelihood may be output, such as a graph representing the probability of complete response as a function of time. The display is text, graphical, audio, or other display. Supporting information, such as values, different model outputs, options, or other supporting information, may be displayed.

The processor 12 operates pursuant to instructions. The instructions, model, matrix, biological data, image data, clinical data, blood biomarkers, uptake data, dataset for creating a model, and/or patient record for modeling of rectal cancer patients are stored in a computer readable memory, such as external storage, memory 14 (e.g., cache, system memory, ROM and/or RAM). The instructions for implementing the processes, methods and/or techniques discussed herein are provided on computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination.

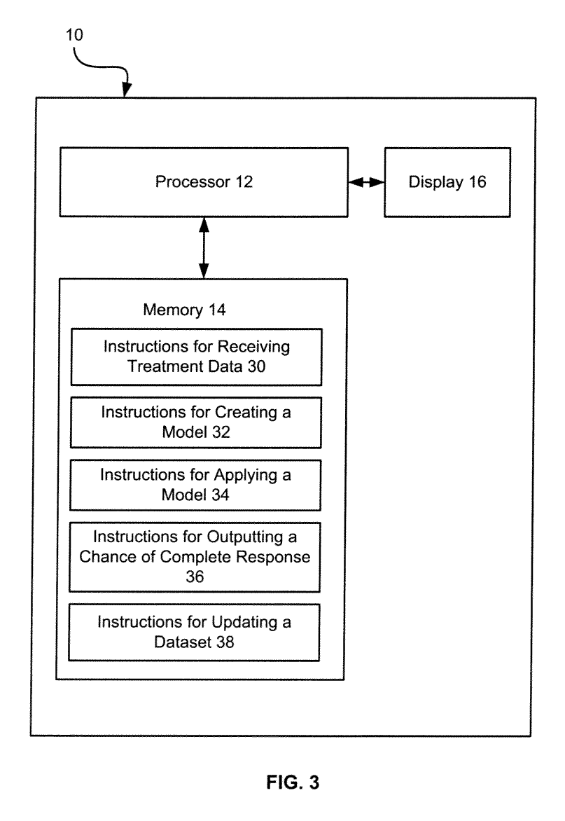

In one embodiment, as shown in FIG. 3, the memory 14 may be a computer readable storage medium having stored therein data representing instructions executable by a programmed processor for predicting complete response. The memory 14 may include instructions for receiving treatment data 30, instructions for creating a model 32, instructions for applying a model 34, instructions for outputting a chance of complete response 36, and instructions for updating a dataset 38. The memory 14 may include additional, different, or fewer instructions.

The instructions for receiving treatment data 30 may be executed to receive treatment data for a disease or a tumor. The instructions 30 may include receiving treatment data from the input 18, reading the treatment data from the memory 14, and/or receiving treatment data from a communication device at a remote location. The instructions for creating a model 32 may include instructions for training a model based on a dataset. The dataset may include data from the patient and/or other patients. The instructions for applying the model 34 may be executed to predict a chance of disappearance of all or substantially all of the disease of the tumor as a function of the treatment data. The model may be used to predict the chance of disappearance, given the treatment data received using the instructions 30. Predicting the chance of disappearance may include determining, calculating, and/or estimating the chance of disappearance such that surgery is not needed. The instructions 34 may include instructions for determining surgical operation information as a function of the predicted chance. The surgical operation information indicates whether a surgical operation is needed to remove the disease. The instructions for outputting the chance of complete response 36 may be executed to output the chance on the display 16. The instructions for updating the dataset 38 may be executed to update the dataset used by the instructions 32. The instructions 38 may update the dataset to reflect the actual outcome of the treatment.

In another embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU or system. Because some of the constituent system components and method acts depicted in the accompanying figures may be implemented in software, the actual connections between the system components (or the process steps) may differ depending upon the manner of programming.

The same or different computer readable media may be used for the instructions, the individual patient data, the model, and the database of previously treated patients (e.g., training data/information). The patient records are stored in the external storage, but may be in other memories. The external storage or the memory 14 may be implemented using a database management system (DBMS) managed by the processor 12 and residing on a memory, such as a hard disk, RAM, or removable media. The external storage may be implemented on one or more additional computer systems. For example, the external storage may include a data warehouse system residing on a separate computer system, a PACS system, or any other now known or later developed hospital, medical institution, medical office, testing facility, pharmacy or other medical patient record storage system. The external storage, an internal storage (memory 14), other computer readable media, or combinations thereof store data for at least one patient record for a patient. The patient record data may be distributed among multiple storage devices.

In other embodiments, the system 10 connects with an imaging system, a blood testing system, and/or other therapy or testing system. For example, the system 10 connects with a CT-PET system and a linear accelerator for radiation therapy. The imaging system scans the patient and provides data representing the scanned region of the patient for transformation by analysis. As another example, the system 10 connects with a database from one or more medical facilities. The data is provided for transformation by modeling. The system 10 assists the user in planning therapy. The output information may be used to determine a post-treatment treatment plan. The system 10 is part of one of these components and/or communicates with the components to acquire treatment data and control treatment.

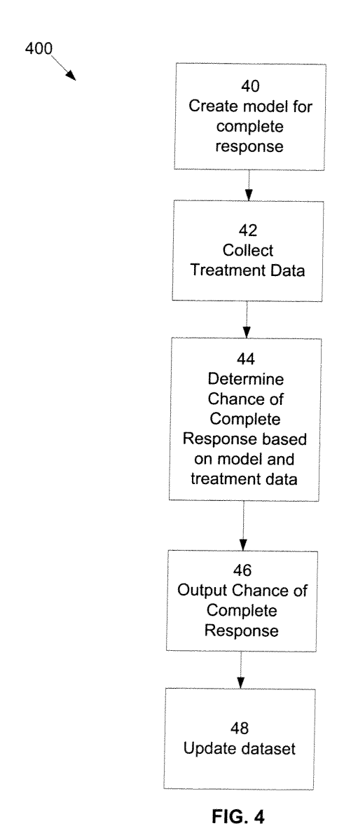

FIG. 4 shows a method 400 for modeling complete response. The model is created and/or applied using treatment data. The method is implemented with the system of FIG. 1, or a different system. The same or different systems may perform the creating and applying stages. For example, one computer is used for development, and a different computer is used for applying the developed models. The models may be developed, and then sold or otherwise distributed for application by others. As another example, the use of the developed models is charged. Users request predictions from the developer, so the model is applied by the same computer used for development or by different computer controlled by the developer.

The acts are performed in the order shown or a different order. Additional, different, or fewer acts may be provided. For example, acts 40 and/or 48 are not provided.

In act 40, a model for complete response is created. The model is created as discussed above, such as machine learning using a training data set. The model may be created using any type of data indicating complete response. Any number of patients may be included in the training data. The data is labeled as appropriate for the desired outcome. The machine-learning algorithm or algorithms are selected. Any now known or later developed algorithm and process for training may be used.

The training information corresponds to the treatment data used for application of the model. Training information is obtained with any desired additional information, such as treatment data, dose data, application data, or other data. The training information may be stored in a database or dataset. The database or dataset may be stored in memory, such as a computer readable storage medium. One or more models are trained, such as determining different models to select the most accurate model and/or the most efficient model. The models may be combined or maintained separately.

In one example, training data from 445 locally advanced rectal cancer patients from Italy was collected retrospectively. These patients received long-term chemotherapy with different radiotherapy (RT) dose. The collected pre-treatment data included age, gender, tumor length, tumor localization, clinical tumor stage (cT) and chemotherapy dose. To identify cases responding with a complete response after chemotherapy, the pathologic reports of the surgical specimens were reviewed for tumor stage after resection (ypT). Multivariate analysis was performed with a 2-norm support vector machine (SVM). The training data may be used to create the model.

In another example, training data from Italy of 78 rectal cancer patients was collected retrospectively. These patients received long-term chemotherapy of 56 Gy and PVI 5-FU at 300 mg/m²·. The collected pretreatment data included gender, age, tumor length, cT and SUVmax from CT/PET imaging. SUVmax is the Maximal Standardized Uptake Value value in a F-18 Fluorodeoxyglucose-Positron Emission Tomography scan. Basically the maximal value of SUV for the tumor voxels. All patients underwent a CT/PET before treatment and 42 days after CRT. The absolute difference (SUVmax) and percent difference (Response Index, RI) of SUVmax between pre- and post-CRT PET scans were also included for evaluation. To identify cases responding with a pCR after CRT, the pathologic reports of the surgical specimens were reviewed for tumor stage after resection (ypT). Multivariate analysis was performed with a 2-norm support vector machine (SVM). The external validation dataset included 21 rectal patients receiving long-term CRT.

The created model or models are validated. A five-fold or other cross validation is performed on patient-data. For example, performance of the model is expressed as the AUC (Area Under the Curve) of the Receiver Operating Characteristic (ROC) and assessed using leave-one-out (LOO) cross-validation and an external validation set. This set includes data from 105 patients treated with long-term chemotherapy. The maximum value of the AUC is 1.0, indicating a perfect prediction model, whereas a value of 0.5 indicates a random chance to correctly predict the complete response.

Once created, the model or models are incorporated onto a computer, such as into hardware, software, or both. The incorporation allows operating, with a processor, combined models or a single model for an individual patient. Values for the predictors of the models are obtained. The medical record, functional imaging data, and/or other source provides values for a specific or individual patient. The model is applied to the individual patient information.

A two-norm Support Vector Machine may be used to build a model. Other machine learning algorithms may be used. Multiple models may be created to test for the most accurate. For example, one prognostic model uses one sub-set of factors, and another prognostic model uses a different sub-set of factors. A risk score may be calculated and a nomogram, a graphical representation of the risk score, may be made for practical use.

The model is trained to predict as a function of the treatment data. The models may be trained to predict as a function of other data. Different models may be trained for different combinations of features. For example, blood biomarkers, such as osteopontin corrected for creatinin clearance, interleukin-8, and carcino-embryonic antigen, may be used together for a model. The model may be trained to include other features, such as body mass index (BMI), WHO performance status, a number of positive lymph node stations, and a gross tumor volume. The values for these features may be derived using any technique.

The features and model are used to predict complete response. For example, the likelihood of complete response is predicted by the model. To derive the likelihood of complete response, the machine learning uses the training data.

To build a multivariate prediction model for complete response, 2-norm support vector machines are used. Complete response outcome is calculated from the start of or at other time relative to the radiotherapy treatment. The mean value of a variable is input if the value is missing. A logarithmic transformation may be applied to obtain more symmetrically distributed data.

A multivariate model, built on a large patient population and externally validated, may be used as a baseline complete response model. The model uses four clinical features: sex, age, WHO performance status (WHO-PS), and body mass index (BMI). To assess the added prognostic value of the blood biomarkers, the baseline model is extended with the blood biomarkers mentioned above.

In act 42, treatment data is collected. Collecting may include receiving. Receiving treatment data may include receiving in response to a request, accessing treatment data from a storage medium, inputting manually, calculating treatment data, or a combination thereof. Other processes for receiving treatment data may be used.

In one embodiment, treatment data is received in response to a request. For example, the processor requests acquisition of the data from a database. In response, the requested treatment data is transferred to and received by the processor 12. Alternatively, the functional information is pushed to the processor. The receipt may occur in response to user input or without direct user input.

In another embodiment, the treatment data is input manually. Alternatively, the data is mined from a database. A processor mines the values from a medical record of the individual patient. Treatment data is mined from unstructured and structured information. If values are available from unstructured data, the values may be mined by searching or probabilistic inference. Other mining may be used, such as acquiring data from a structured computerized patient record (CPR). The mined and/or manually input values are applied to the combined models to obtain a complete response probability.

Where a value for an individual patient is not available, a value may be assumed, such as using an average. Alternatively, the field may be left blank. For example, one of the questions asked is whether the patient has been previously treated for rectal cancer. If there is no evidence provided in the patient record if the patient has had rectal cancer, then the system leaves this blank or records that the patient has not had rectal cancer, since the prior probability (based on the percentage of people having rectal cancer) suggests that the rectal cancer patient is probably not a repeat victim

In act 44, a chance of complete response is determined. The chance of complete response is based on the model and treatment data. The chance of complete response may be a complete response prediction. The complete response prediction may be a mathematical probability, non-mathematical probability, indication, likelihood, or other chance of complete response.

In act 46, the indication of chance of complete response is output. The indication of chance is output to a display. The indication of chance may be represented as an image representing the chance. The image may represent a prediction positive image or a prediction negative image. Alternatively or additionally, the output is an image of a report indicating the post-treatment treatment plan. A table, graph, or other output may be provided.

The output is to a display, such as an electronic display or a printer. The output may be stored in memory or transferred to another computer. The chance of complete response information is included in a treatment plan. The chance of complete response may be used to schedule a surgical operation.

In act 48, a database is updated. Once the actual treatment response is determined, the datasets used to create the complete response models may be updated. Updating may include adding to, replacing, substituting, or other amending a preexisting database or dataset.

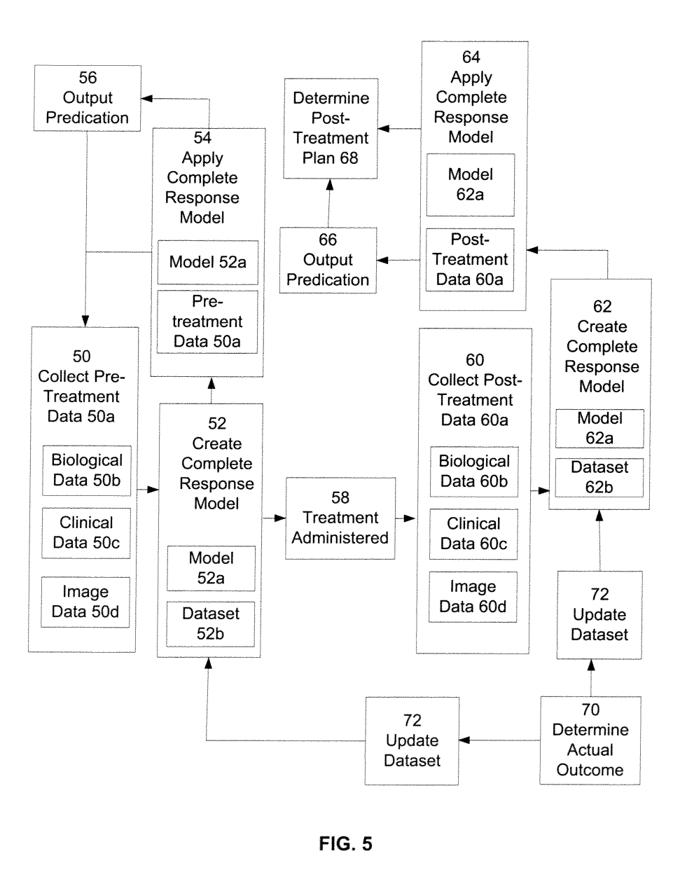

FIG. 5 illustrates a flow chart of one embodiment of treating a rectal cancer tumor. In act 50, pre-treatment data may be collected. The pre-treatment data may be collected by examining the patient, the patient's medical records, or using an imaging system, such as a CT or PET system, to examine the rectal cancer tumor. Other processes for collecting pre-treatment data may be used. The pre-treatment data 50a may include pre-treatment biological data 50b, clinical data 50c, image data 50d, or a combination thereof.

In act 52, a complete response model 52a is created using, for example, a patient dataset 52b. The patient dataset 52b may include pre-treatment and post-treatment data for the patient and/or other patients. The dataset 52b may include actual outcomes to treatments. Act 52 is optional as the model 54a may have been previously created. Once the pre-treatment data 50a is collected, the treatment may be administered, as shown in act 58. However, applying the complete response model 52a given pre-treatment data 50a, as shown in act 54, may be beneficial to setting the treatment dose to be administered. For example, when a complete response prediction indicates that there will not be a complete response, the medical professionals may alter the treatment dose until the complete response prediction indicates that there will be a complete response. If the treatment dose becomes so large that it is unsafe for the patient, the medical professionals may cancel the treatment and proceed to a surgical operation. As a result, the patient is spared from a treatment that is likely to be unsafe or ineffective in treating the rectal tumor. The complete response prediction may be output, as shown in act 56. The complete response prediction may be output on a display, monitor, printer, or other textual, audio, or graphical output device.

Referring back to act 58, the treatment may be administered to the patient. Administrating treatment may include applying a treatment dosage, such as a radiation dosage, chemotherapy dose, or other therapy dose to the rectal cancer tumor. For example, the treatment may be chemo-radiotherapy. After the treatment is administered, post-treatment data 60a may be collected, as shown in act 60. The post-treatment data 60a may be collected at any time after the treatment is administered. Post-treatment data 60a may include post-treatment biological data 60b, clinical data 60c, image data 60d, or any combination thereof. The post-treatment data 60a may relate to the patient being treated. Collecting may include calculating, gathering, determining, accessing, reading, inputting, or requesting. A complete response model 62a may be created, as shown in act 62, using a dataset 62b. The dataset 62b may be the same dataset as dataset 52b or other, different, dataset. The complete response model 62a may be created before, after, or during any of the previous acts. For example, the complete response model 52a may be used in act 62. Since different features are available, the model 62a may be a different model than created in act 52. In act 62, the complete response model 62a may be created during the collection of post-treatment data 60a. In yet another example, a complete response model 62a may be created when the dataset 62b is updated or from a previously acquired dataset. In act 64, the complete response model 62a may be applied given the post-treatment data 60a. A complete response prediction is determined from the application of the complete response model 62a. Other data may also be used. For example, a difference between pre-treatment data 50a and post-treatment data 60a may be used when applying the complete response model.

In act 66, the complete response prediction is output. Alternatively, or additionally, the complete response prediction may be used to determine a post-treatment plan. For example, if the complete response prediction indicates that complete response is likely, the treatment plan may be to refrain from a surgical operation until after actual determination, as shown in act 70. Actual determination may be made after the regression period. The surgical operation may be performed if it is determined that there is not complete response. However, if the complete response prediction indicates that complete response is not likely, the treatment plan may be to schedule and/or perform a surgical operation.

Referring to act 70, the actual treatment response may be determined. The treatment response may be complete response, partial response, stable disease, progressive disease, or other response to treatment. A partial response may indicate that there is some disease remaining in the body, but that there has been a decrease in size or number of lesions (e.g., by 30% or more). Stable disease may indicate that the disease has remained virtually unchanged in the size and number of lesions (e.g., generally, a less than 50% decrease or a slight increase in size would be described as stable disease). Progressive disease may indicate that the disease has increased in size or number on treatment. The treatment response may be determined after the regression time period. Once the treatment response is determined, the datasets used to create the complete response models, for example, in acts 52 and/or 62, may be updated, as shown in acts 72. One benefit of updating the datasets is that a comprehensive dataset may be used to create the models. More variables used to create the model may increase the accuracy of the model.

Various improvements described herein may be used together or separately. Any form of data mining or searching may be used. Although illustrative embodiments have been described herein with reference to the accompanying drawings, it is to be understood that the invention is not limited to those precise embodiments, and that various other changes and modifications may be affected therein by one skilled in the art without departing from the scope or spirit of the invention.

1. A system for modeling complete response prediction, the system comprising:
an input operable to receive treatment information representing treatment data for treating a tumor;
a processor operable to use a model to predict an indication of a chance of a complete response of the tumor to treatment given the treatment data, the prediction being a function of the treatment data, the complete response including a disappearance of all or substantially all of a disease; and
a display operable to output an image as a function of the complete response prediction.

2. The system of claim 1, wherein the treatment is chemo-radiotherapy treatment and the tumor is a tumor of a rectal cancer.

3. The system of claim 1, wherein the treatment data includes pre-treatment data and post-treatment data.

4. The system of claim 3, wherein the pre-treatment data includes pre-treatment biological data, pre-treatment clinical data, and pre-treatment image data, the biological data and clinical data being determined without imaging the tumor and the pre-treatment image data being determined with positron emission tomography imaging.

5. The system of claim 4, wherein the pre-treatment biological data includes age, gender, weight, genetic information, and height of a patient that is being treated, the pre-treatment clinical data includes type, strength, and length of treatment, and the pre-treatment image data includes WHO performance, tumor size, and tumor location.

6. The system of claim 4, wherein the post-treatment data includes post-treatment biological data, post-treatment clinical data, and post-treatment image data, the biological data and clinical data being determined without imaging the tumor and the pre-treatment image data being determined with positron emission tomography imaging.

7. The system of claim 6, wherein the processor is operable to use the model to predict complete response of the tumor as a function of a difference between the pre-treatment data and the post-treatment data.

8. The system of claim 1, wherein the image may be a prediction positive image or prediction negative image, the prediction positive image indicating a probability of complete response and the prediction negative image indicating a probability of a non-complete response.

9. The system of claim 1, wherein the probability of complete response indicates that a surgical operation is not needed, and the probability of non-complete response indicates that a surgical operation is needed.

10. The system of claim 1 wherein the model is a machine-learned model.

11. The system of claim 1, wherein the model uses a feature vector comprising treatment data collected from previous treatments.

12. In a computer readable storage medium having stored therein data representing instructions executable by a programmed processor for predicting complete response, computer readable storage medium comprising:
instructions for receiving treatment data for a disease of a tumor, the treatment data including pre-treatment data and post-treatment data;
instructions for predicting a chance of disappearance of all or substantially all of the disease of the tumor as a function of the treatment data;
instructions for determining surgical operation information as a function of the predicted chance, the surgical operation information indicating whether a surgical operation is needed to remove the disease; and
instructions for outputting an image representing the surgical operation information.

13. The computer readable medium of claim 12 wherein receiving treatment data includes receiving positron emission information of the tumor.

14. The computer readable medium of claim 12 wherein predicting comprises modeling as a function of a probability of complete response given the treatment data.

15. The computer readable medium of claim 14 wherein modeling comprises: creating a model from a dataset of previous outcomes and applying the model to the treatment data.

16. The computer readable medium of claim 15 wherein outputting includes determining an actual outcome of the treatment of the tumor and updating the dataset.

17. A method for modeling complete response predictions, the method comprising:
collecting treatment data for treatment of a tumor, the treatment data including pre-treatment data and post-treatment data
classifying response of a tumor as a function of complete response probability given the collected treatment data, the complete response probability having been machine-learned from a dataset for other patients having treatment data before and after treatment by radiation;
determining response information as a function of the response, the response information indicating whether there will be a complete response to treatment for the patient; and
outputting the response information.

18. The method of claim 17 wherein classifying comprises modeling a complete response probability as a function of treatment data, wherein determining response information comprises determining a probability that all or substantially all of a disease disappeared.

19. The method of claim 18 wherein outputting the response information includes displaying a probability image, the probability image indicating the complete response probability.

20. The method of claim 17 wherein the treatment data includes pre-treatment data and post-treatment data.

21. The method of claim 20 wherein classifying comprises classifying as a function of a difference between the pre-treatment data and post-treatment data.

22. The method of claim 17 further comprising determining an actual outcome of the treatment and updating the dataset to indicate the actual outcome.
